(19) United States
(12) Patent Application Publication
(10) Pub. No.: US 2018/0322502 A1
(43) Pub. Date: Nov. 8, 2018

(54) DATA SECURITY SYSTEM USING INTERACTION CHANNEL CODE

(71) Applicant: Kevin Weller, San Anselmo, CA (US)

(72) Inventor: Kevin Weller, San Anselmo, CA (US)

(21) Appl. No.: 15/585,063

(22) Filed: May 2, 2017

(51) Int. Cl. G06Q 20/40; H04L 29/06

(52) U.S. Cl. CPC G06Q 20/4018; G06F 21/6245; H04L 63/0853; H04L 63/0861

(57) ABSTRACT

A data security system is disclosed. The data security system includes a portable device with an interaction channel code. A user may capture an image of the portable device and the interaction channel code, and the captured image may be converted to image data. The image data may be provided to a remote server computer, which may validate the interaction channel code, and confirm that the transaction being conducted is associated with that interaction channel code.

### BACKGROUND

Data security is important in electronic transactions such as electronic access transactions and electronic commerce transactions. For example, when conducting an electronic transaction such as a transaction to access data (e.g., medical records data) in a remote computer, a fraudulent user could obtain an authentic user's login credentials and then attempt to impersonate the authentic user and conduct unauthorized transactions. In another example, a fraudulent user may attempt to impersonate a person while conducting an online payment transaction. If the fraudulent user is able to successfully impersonate the real user, then the fraudulent user can conduct fraudulent payment transactions at the expense of the real user. Thus, there is a need to provide for improved data security systems.

Embodiments of the present disclosure address these and other technical problems, individually and collectively.

### BRIEF SUMMARY

Embodiments of the disclosure are directed to methods and systems that allow for improved authentication in a distributed system.

One embodiment of the invention is directed to a method comprising: receiving, by a user communication device, an authentication request message; capturing, by the user communication device, an image of a portable device comprising an interaction channel code; generating, by the user communication device, portable device image data in response to capturing the image of the portable device; transmitting, by the user communication device, the portable device image data to a server computer, wherein the server computer thereafter determines the interaction channel code from the portable device image data, and then generates validation data after determining that the interaction channel code is authentic. In some examples, the server computer may verify the complete image of the portable device or particular features in the image, to determine the portable device is authentic.

Other embodiments of the invention can be directed to a user communication device configured to perform the above method.

Another embodiment of the invention is directed to a method comprising: transmitting an authentication request message to a user communication device; receiving from the user communication device, portable device image data of a portable device comprising an interaction channel code; and determining the interaction channel code from the portable device image data; and generating, validation data if the interaction channel code is authentic.

Other embodiments of the invention can be directed to a server computer configured to perform the above method.

These and other embodiments of the invention are described in further detail below.

### BRIEF DESCRIPTION OF THE DRAWINGS

FIG. 1 shows a block diagram of an authentication system according to an embodiment of the invention.

FIG. 2 shows a block diagram of an ACS computer according to an embodiment of the invention.

FIG. 3 shows a block diagram of a user communication device according to an embodiment of the invention.

FIG. 4 illustrates a flow chart for registering the portable device according to embodiments of the invention.

FIGS. 5A-5B show illustrative portable devices according to embodiments of the invention.

FIG. 6 shows various views of various portable devices according to embodiments of the invention.

### DETAILED DESCRIPTION

Embodiments of the disclosure are directed to methods and systems that allow for improved authentication. Particularly, the authentication of a user during a transaction may include, at least in part, a confirmation that the user has possession of a portable device with an interaction channel code. By confirming that the user conducting a transaction has possession of a portable device with an appropriate interaction channel code, a remote computer with which the user is interacting can be assured that it is conducting the transaction with an authentic user.

Illustratively, in some embodiments, the interaction channel code (e.g., a 3 or 4 digit cryptogram) can be printed on a portable device such as a card. The user may then take a picture of the interaction channel code on the card with a mobile phone. The mobile phone may generate data representing an image of the card with the interaction channel code. This portable device image data may then be transmitted by the mobile phone to a remote authentication server. The remote authentication server may then determine if the portable device image data contains the interaction channel code, and may determine that the interaction channel code is appropriate for the interaction channel in which the transaction is being conducted. For example, the interaction channel may be an Internet based transaction, and the interaction channel code is only useful for use in that interaction channel. Thus, the interaction channel code, in this example, would not be useful to authenticate a user in a physical point of sale transaction. Also, by confirming that the interaction channel code is the expected one for the particular transaction channel, the remote authentication server computer can confirm that the person conducting the transaction is in physical possession of the particular portable device that was previously assigned and/or provided to that user. After the remote authentication server determines that the interaction channel code is authentic, and that other data indicates that the user conducting the transaction is authentic, the authentication server computer may generate and transmit a cryptogram or other validation data (e.g., to a merchant or to an entity that will provide secured data) indicating that the portable device has been authenticated or verified for use in the transaction.

In addition to the interaction channel code, the image of the portable device that is captured by the user communication device can comprise a visual representation of an account identifier (e.g., a primary account number), a user name, an expiration date, a security code, verification value, and/or other data. This additional information may also be used by a remote server computer to determine that the portable device is authentic. In some embodiments, to provide even better data security, the interaction channel code may be encoded into a machine readable code and/or hidden on the portable device. In the latter case, a filter or decoder on the user communication device may be used to obtain the interaction channel code from the hidden interaction channel code on the portable device.

In further embodiments, the interaction channel code may be at different locations on different portable devices used by different users. For example, one portable device for one user may have an interaction channel code printed on the front, while another portable device for a different user may have an interaction channel code printed on the back. Further, two or more interaction channel codes for two or more different interaction channels may be on the same portable device. Different portable devices may have different numbers of interaction channel codes at different locations on the portable device. This may prevent an unauthorized, fraudulent person from knowing where to find the interaction channel code on a portable device. The interaction channel code may be printed, adhered, or embossed onto the portable device. In other embodiments, a portable device may have multiple interaction channel codes, each suitable for validating a transaction for a particular interaction channel. During the authentication process, prompts may be provided to the user to inform the user as to what part of the portable device to capture with a camera. For example, when user A performs an e-commerce transaction, an authentication server may prompt the user to take a picture of an interaction channel code on the front of a card. When user B performs an e-commerce transaction, the authentication server may prompt the user to take a picture of an interaction channel code on the back of the card.

Prior to discussing specific embodiments of the disclosure, some descriptions of some terms may be useful.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers.

An “authorization computer” may typically refer to a computer operated by an entity that can authorize a request. The entity may be, for example, a business entity (e.g., a bank) that maintains an account for a user. For example, an authorization computer may be the bank that issues a credit account to an account holder. An authorization computer may also issue account parameters associated with the account to a portable device on a substrate or a user communication device that stores account parameters. An authorization computer may be associated with a host system that performs some or all of the functions of the authorization computer on behalf of the authorization computer.

A “resource provider computer” may typically be a computer operated by an entity that provides resources. The resource provider can be an entity that engages in transactions and can sell goods or services, or provide access to goods or services.

An “authorization request message” may be an electronic message that is sent to request authorization for a transaction. The authorization request message can be sent to a transaction processing network and/or an authorization computer associated with a portable device. An authorization request message according to some embodiments may comply with ISO 8583, which is a standard for systems that exchange electronic transaction information associated with a transaction made by a user using a transaction device or transaction account. The authorization request message may include information that can be used to identify an account (e.g., an account identifier, a user name, etc.). An authorization request message may also comprise additional data elements such as one or more of a service code, an expiration date, etc. An authorization request message may also comprise transaction information, such as any information associated with a current transaction, such as the transaction amount, resource provider identifier, resource provider location, etc., as well as any other information that may be utilized in determining whether to identify and/or authorize a transaction. The authorization request message may also include other information such as information that identifies the access device that generated the authorization request message, information about the location of the access device, etc.

An “authorization response message” may be an electronic message reply to an authorization request message. The authorization response message can be generated by an authorization computer or a transaction processing network. The authorization response message may include, by way of example only, one or more of the following status indicators: Approval—transaction was approved; Decline—transaction was not approved; or Call Center—response pending more information, resource provider computer must call the toll-free authorization phone number. The authorization response message may also include an authorization code, which may be a code that an authorization computer returns in response to an authorization request message in an electronic message (either directly or through the transaction processing network) to the resource provider computer that indicates approval of the transaction. The code may serve as proof of authorization. As noted above, in some embodiments, a transaction processing network may generate or forward the authorization response message to the resource provider computer.

A “user communication device” may be any suitable device that includes one or more electronic components and that can perform computations. For example, a user communication device may have at least one processor coupled to a memory that stores instructions or code for execution by the processor. Examples of user communication devices may include portable communication devices such as mobile phones, tablet computers, laptops, netbooks, ultrabooks, personal computer, etc. A user communication device may be in the form of a mobile device such as a mobile phone (e.g., smart phone, cellular phone, etc.), tablets, portable media player, personal digital assistant devices (PDAs), wearable device (e.g., watch, health monitoring device such as a fitness band, etc.), electronic reader device, etc. A user communication device may have the ability to communicate with remotely located computers via a data network. A user communication device can be configured to transmit and receive data or communications to and from other communication devices.

An “account identifier” may include an identifier associated with an account. An example of an account identifier may be a primary account number (PAN) issued by an authorization computer for an account (e.g., credit, debit, etc.). For instance, in some embodiments, an account identifier may include a sixteen digit numerical value such as “4147 0900 0000 1234.” The first six digits of the account identifier (e.g., “414709”), may represent an authorization computer identifier (BIN) that may identify the authorization computer associated with the account identifier (e.g., the authorization computer that issued the identifier and/or maintains the account, etc.).

“Portable device image data” may include any suitable data representing an image of at least a portion of a portable device such as a card. The portable device may comprise a substrate with the image embossed or printed with the substrate. Portable device image data may be present in any suitable data format including GIF, TIFF, JPEG, PCX, PDF, etc.

An “interaction channel code” may include any suitable value that can be used to authenticate a particular interaction channel in which a transaction is being conducted. Examples of interaction channels may include Internet-based transactions, e-commerce transactions, physical point of sale transactions, Quick Response (QR) code transactions, short range transactions (e.g., Bluetooth™), etc. The value of the interaction channel code can include any suitable number or type of characters including numbers, letters, and/or symbols. In some examples, the interaction channel code is a QR code, bar code, or some other image that contains numbers, letters, or symbols when the data is decoded from the image. In some embodiments, the interaction channel code is a cryptogram, which may be derived by encrypting data with an encryption key. The data used to form the cryptogram can be derived from other data associated with the portable device (e.g., an account number, a portable device identifier, an expiration date, etc.).

A “key” may refer to a piece of information that is used in a cryptographic algorithm to transform input data into another representation. A cryptographic algorithm can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc.

A “transaction processing network” may include a network that can perform operations in association with processing transactions. An exemplary transaction processing network may include data processing subsystems, networks, and operations used to support and deliver authorization services, exception file services, transaction scoring services, processing and routing of messages related to transactions, and clearing and settlement services. An exemplary transaction processing network may include VisaNet™. Transaction processing networks such as VisaNet™ are able to process credit transactions, debit transactions, and other types of commercial transactions. VisaNet™, in particular, may include a VIP system (Visa Integrated Payments system) which processes authorization requests and a Base II system which performs clearing and settlement services.

A “processor” may include any suitable data computation device or combination of such devices. An exemplary data processor may comprise one or more microprocessors working together to accomplish a desired function. The processor may include a CPU that comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “computer readable medium” may be any suitable device or devices that can store electronic data. A computer readable medium may be embodied by one or more memory devices. Examples of memory devices include memory chips, disk drives, etc. Such memories may operate using any suitable electrical, optical, and/or magnetic mode of operation.

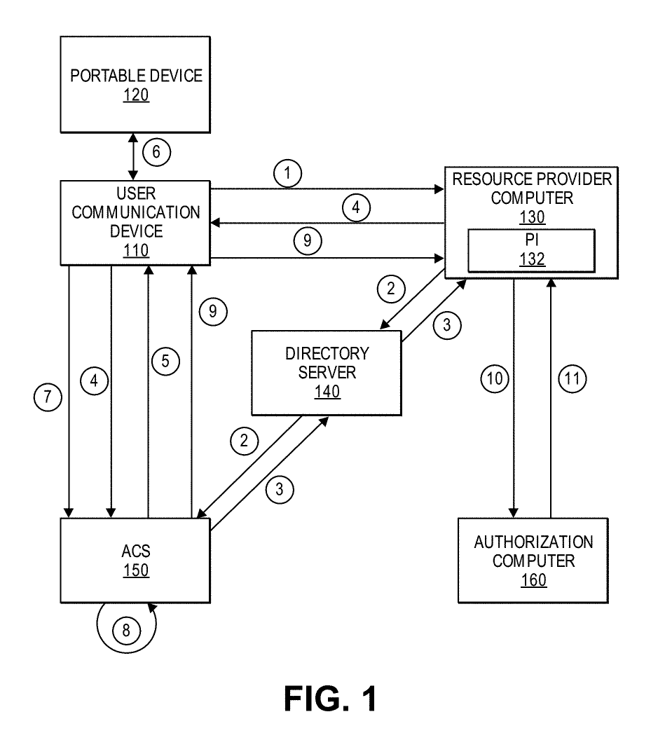

FIG. 1 shows a system according to an embodiment of the disclosure. The system includes a user communication device 110 and a portable device 120 in possession of a user. The user communication device 110 may be a mobile phone or a personal computer (e.g., a laptop computer). The user communication device 110 may be in communication with a resource provider computer 130 and an access control server (ACS) 150. The resource provider computer 130 may be in communication with the user communication device 110, directory server 140 (to access the ACS 150), a service computer, a transaction processing network, and an authorization computer 160, via the communication channel. The user communication device 110 may be in communication with the resource provider computer 130 and the ACS 150.

The components in FIG. 1 may communicate using any suitable type of communications network(s). Examples may include direct interconnections; the Internet; Local Area Networks (LANs); Metropolitan Area Networks (MAN); Operating Missions as Nodes on the Internet (OMNI); secured custom connections; Wide Area Networks (WAN); wireless networks (e.g., employing protocols such as, but not limited to a Wireless Application Protocol (WAP), I-mode, etc.); and/or the like.

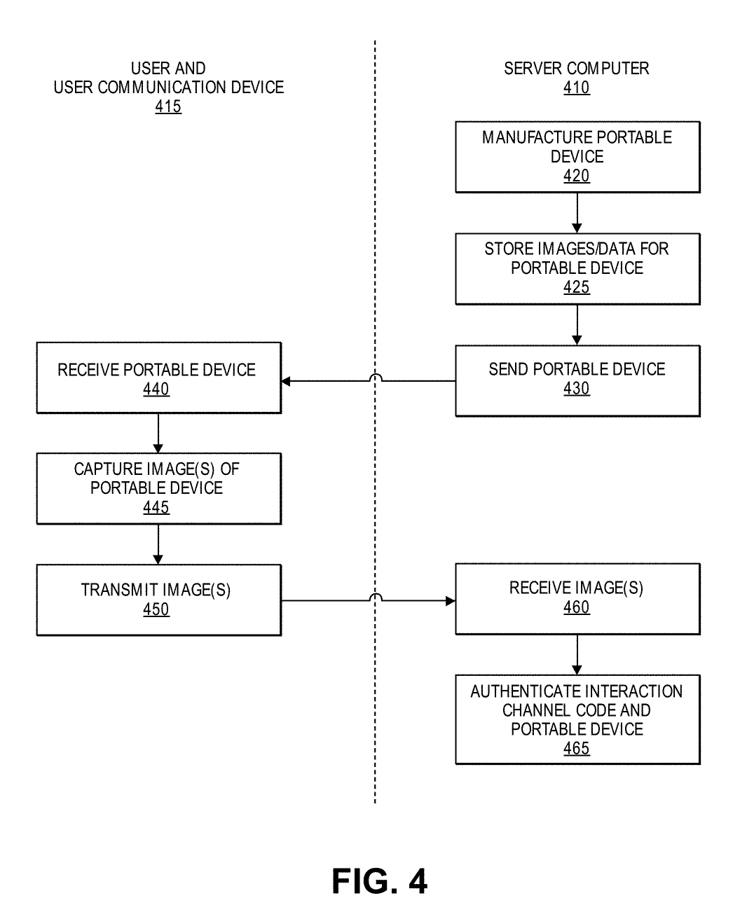

In some examples, the portable device 120 may be registered with the authorization computer 160 and provided to the user operating the user communication device 110 prior to the process illustrated in FIG. 1. Additional details regarding the registration process are illustrated in FIG. 4.

In FIG. 1, at step 1, user operates user communication device 110 to initiate an electronic transaction with a resource provider computer 130. For example, using the user communication device 110, the user may access the resource provider computer 130 via the Internet using a web browser (e.g., by browsing to www.acme.com for resource provider Acme Co.). The user communication device 110 may order or attempt to access resources from the resource provider computer 130 by identifying one or more resources provided by the resource provider computer 130 and providing the resource provider computer 130 with an account identifier associated with the portable device 120. The user may also provide other information, such as an expiration date, to the resource provider computer 130. In an embodiment, a secure communication system, such as Secure Sockets Layer (SSL), is used for all communications.

In response to receiving the account information and the identification of the resources, the resource provider computer 130 may initiate an authentication procedure to determine whether the account information is valid and has been provided by an authorized user. In some embodiments, there are numerous authorization computers and each authorization computer is responsible for authenticating its own account identifiers. To authenticate the account information, the resource provider computer 130 may locate the authentication service of the authorization computer associated with the account information.

At step 2, the resource provider computer 130 may determine if the account identifier from the user communication device 110 is enrolled in an authentication or verification program by sending a transmission to the access control server (ACS) 150. For example, the resource provider computer 130 sends a verifying enrollment request (VEReq) to a directory server 140 to locate the appropriate authentication computer. In an embodiment, all authentication-related communication may be coordinated by an authentication plug-in 132 (PI) integrated with the resource provider computer 130.

The verifying enrollment request may include at least a portion of the account information to be used by the directory server 140 to identify the authentication computer associated with the portable device 120. In an embodiment, each authentication computer is assigned a different range of account identifiers, and a list of all authentication computers and their associated account identifiers ranges may be stored with the directory server 140. By comparing the account identifiers with the list of authentication computers, the directory server 140 can able to identify the appropriate authentication computer.

After identifying the authentication service, the directory server 140 forwards the verifying enrollment request to an access control server (ACS) 150 associated with the account identifier. The ACS 150 may determine whether the information provided in the verifying enrollment request can be authenticated. Account information may not be able to be authenticated by the ACS 150 if, for example, the account information does not include a valid account identifier, or if there is no authentication information associated with the account identifier.

At step 3, the ACS 150 may respond back to the resource provider computer 130, with a response that includes a confirmation or denial that the account identifier is enrolled. For example, if the account information provided in the verifying enrollment request can be authenticated, the ACS 150 sends a verified enrollment response (VERes) back to the directory server 140. The verified enrollment response may include a message indicating that the ACS 150 can authenticate the account information and a pseudonym corresponding to the account identifier. The pseudonym can be any type of code or number that can be uniquely linked to the account information by the ACS 150 at a later time. The verified enrollment response may also include a uniform resource locator (URL) to be accessed by the user communication device 110 to authenticate the user. In some examples, the URL is associated with a web site provided by the ACS 150. Upon receiving a verified enrollment response from the ACS 150, the directory server 140 may forward the verified enrollment response to the resource provider computer 130.

At step 4, from the received verified enrollment response (VERes), the resource provider computer 130 may generate an authentication request to transmit to the user communication device 110. The authentication request may include the pseudonym created by the ACS 150 and transaction information associated with the resources identified by the user when browsing the resource provider computer 130. The resource provider computer 130 may then forward the authentication request to the user communication device 110. In an embodiment, the authentication request is sent to the user communication device 110 with a web page having a redirection command, such as a Hypertext Transfer Protocol (HTTP) redirect, to a web site hosted by the ACS 150. This web page may also include a URL for returning information to the resource provider computer 130.

In response to the authentication request being received from the resource provider computer 130, the user communication device 110 accesses an interface provided by the ACS 150. The interface may be accessed by an application module stored with the user communication device 110 or may be accessed through a browser application stored with the user communication device 110, which communicates with a web site hosted by the ACS 150. In either embodiment, the user communication device 110 supplies the ACS 150 with the pseudonym originally created by the ACS 150 for the verified enrollment response (e.g., passively or actively providing the pseudonym, etc.).

At step 5, the ACS 150 may transmit the authentication request to the user communication device 110 with a prompt (either audio or visual) for the user to capture an image of the portable device 120 containing the interaction channel code. The prompt may include specific instructions as to what portion of the portable device is to be captured in an image by a camera. For example, the prompt may include an instruction such as “Take a picture of the magnetic stripe of your card” or “Take a picture of the four digit code on the front of your card.” In some embodiments, the prompt may include a second uniform resource locator (URL) that directs the user communication device 110 as to where to send the image, or the ACS 150 may provide for the ability to upload the portable device image data.

At step 6, user communication device 110 captures an image of the portable device 120 including an interaction channel code using a scanning device associated with the user communication device 110. For example, the user can operate the user communication device 110 to capture an image of at least a portion of the portable device 120. The user communication device 110 may then covert the captured image to portable device containing the interaction channel code to portable device image data. User communication device 110 may store the portable device image data within a memory of the user communication device 110, and/or may transmit or upload the portable device image data to the ACS 150.

At step 7, user communication device 110 sends portable device image data and/or other information to the ACS 150. The other information provided to the ACS 150 may include a password, user name, pseudonym, etc. Other information may also include information associated with the user communication device 110, such as a device ID or an IP address of the user communication device 110.

In an embodiment, the ACS 150 matches the information received via the authentication request with the information previously created for verified enrollment response. In a further embodiment, the pseudonym expires after a limited period of time, for example five minutes, to prevent fraudulent reuse of the authentication request.

At step 8, ACS 150 validates the information received from the user communication device 110. For example, the ACS 150 may verify (or authenticate) the interaction channel code determined from the received portable device image data to verify that the user is in possession of a legitimate portable device, and that the channel in which the transaction is being conducted corresponds to that interaction channel code. The ACS 150 may also verify a user password to determine something that the user knows. The ACS may further verify the device information to determine that the user communication device 110 is an authentic one. Device information and/or passwords may be stored by the ACS 150 during an enrollment phase. By verifying all three of these pieces of information, the ACS 150 may determine that the transaction is being conducted by an authentic user using an authentic user communication device 110 in the correct transaction channel. Consequently, the likelihood that the transaction being conducted is fraudulent is significantly reduced as compared to conventional systems. Once all of the received information is validated by the ACS, the ACS may generate a validation cryptogram. The validation cryptogram may confirm that the ACS validated the information received from the user communication device 110.

At step 9, the ACS 150 transmits the cryptogram within an authentication response to the user communication device 110, which transmits the cryptogram to the PI 132 (associated with the resource provider computer 130). If the authentication information provided by the user communication device 110 is validated, the authentication response includes the validation cryptogram which indicates that authentication was successful. Alternatively, the authentication response can include a message indicating that the authentication failed. In a further embodiment, the authentication response also includes an error code identifying the reason for authentication failure.

After receiving the authentication response with the cryptogram, the resource provider computer 130 may initiate a transaction. At step 10, the resource provider computer 130 may generate an authorization request message that comprises the account identifier (from step 1). For example, the resource provider computer 130 charges the account identifier associated with the portable device 120 by transmitting the authorization request message with the account identifier to a service computer, then to a transaction processing network. The transaction processing network then sends the authorization request message over a private association network to be processed by the authorization computer 160 associated with the account identifier.

At step 11, the authorization computer 160 approves or denies the transaction and generates an authentication response message. The authorization response message is transmitted back to the resource provider computer 130, via the transaction processing network and the service computer.

At the end of the day or at some other time, a clearing and settlement process can occur between the service computer, the transaction processing network, and the authorization computer 160. No clearing and settlement will take place if the transaction is declined.

In some examples, the ACS 150 validates (or authenticates) the interaction channel code from the portable device image data by deriving or decrypting it. The ACS 150 could use a cryptographic process to decrypt previously encrypted information from the portable device 120 (e.g., account identifier, name, CVV2, expiry date, etc.) using an encryption key known only to the authorization computer 160 or trusted third party. The decrypted information may be associated with the portable device 120 and this can verify that the interaction channel code is specifically associated with that portable device 120. For example, the interaction channel code may be derived encrypted data including an account number printed on the portable device 120. Thus, if the decrypted interaction channel code reveals the account number, then the ACS 150 can be assured that the interaction channel code is genuine. Alternatively, the ACS 150 could recreate the interaction channel code using the same process and same inputs that was used to create the interaction channel code on the portable device 120. The recreated interaction channel code can be compared with the received interaction channel code. If they match, then the received interaction channel code may be deemed authentic. As shown above, in some embodiments, the interaction channel code need not be stored by the ACS 150 for verification purposes, but may be derived when needed. Using derived data eliminates the need for the authorization computer 160 or trusted third party to store the unique information.

In some examples, the user communication device 110 may analyze the portable device image data locally or transmit the image data to be analyzed remotely. For example the user communication device 110 may capture an image of the portable device 120 containing the interaction channel code. The interaction channel code is hidden from normal view and may be obscured by other patterns, colors, or optical elements on the portable device. When the user communication device 110 takes a picture of the portable device 120, the user communication device 110 may convert the image of the portable device to portable device image data. The user communication device 110 (or the ACS 150) may then apply a filter or other image decoding algorithm to the image data to reveal the actual interaction channel code. One advantage to obscuring the interaction channel code is that an unauthorized person that has possession of the portable device 120 (e.g., a waiter at a restaurant) cannot simply write down or store the interaction channel code when the portable device 120 is in their possession.

It is understood that embodiments of the invention are not limited to what is illustrated in FIG. 1. For example, in some embodiments, the system may primarily comprise the ACS 150 or a similar authentication computer, the resource provider computer 130, and the user communication device 110, without the directory server 140, or the authorization computer 160. In still other embodiments, the functions of the resource provider computer 130 and the ACS 150 may be combined into one computer or computer system.

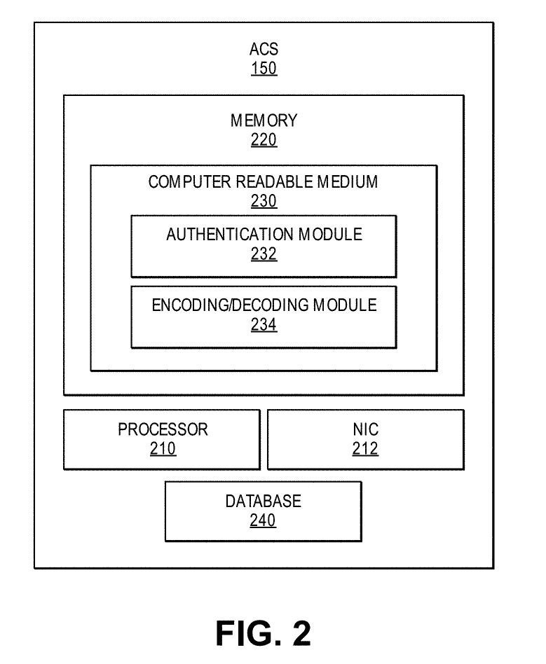

FIG. 2 shows a block diagram of an ACS computer according to an embodiment of the disclosure. The ACS computer 150 may include a processor 210, which is operatively coupled to a memory 220, and a network interface controller (N IC) 212. The network interface controller (NIC) 212 can allow the ACS computer 150 to communicate with the user communication device 110 and the directory server 140 over one or more communication channels. The memory 220 may comprise a computer readable medium 230 and may store an authentication module 232 and an encoding/decoding module 234.

The authentication module 232 may be stored as computer code on the memory 220. The authentication module 232 may, in conjunction with the processor 20A, perform any suitable type of authentication functions. Examples of suitable authentication functions may include confirming that the source of the data is accurate. This may include identifying a device identifier of the user communication device 110 and comparing the received device identifier with a stored device identifier (e.g., from a profile, etc.). The device identifier may comprise any suitable information that serves to identify a device. Examples of a device identifier include a Mobile Station International Subscriber Directory Number (MSISDN), a phone number, a Short Message Service message (SMS) address, an internet protocol (IP) address, or any other information that may be used to identify a mobile device. In some embodiments, a device identifier can include a unique device number, such as an international mobile station equipment identity (IMEI) number, a unique serial number (i.e., integrated circuit card identifier (ICCI)) of a subscriber identification module (SIM) card, or a unique international mobile subscriber identity (IMSI).

The authentication module 232 may also be configured to generate and process the verifying enrollment request (VEReq) and the verified enrollment response (VERes). The verifying enrollment request (VEReq) and the verified enrollment response (VERes) may be received and transmitted with the directory server 140 during the authentication process. In some examples, the authentication module 232 may determine account information associated with the user from the authentication procedure conducted with the resource provider computer 130 as well. The authentication module 232 may also, in conjunction with the processor 210, determine the sender of the image data from a message header or metadata transmitted with the image data. The message header of metadata may comprise a device identifier of the device that transmitted the portable device image data. The authentication module 232, in conjunction with the processor 210, may also determine if an interaction channel code is authentic and/or validates the transaction channel that is currently being used. The authentication module 232 may also be programmed to perform any of the authentication functions described herein including interaction channel code and/or password verification.

The encoding/decoding module 234 may be stored as computer code on the memory 220. The encoding/decoding module 234 may, in conjunction with the processor 210, receive portable device image data, and analyze and/or decode the any image represented by the portable device image data to determine an interaction channel code captured in the portable device image data. The encoding/decoding module 234 may also include filtering software for filtering through image data to recover an interaction channel code from an obscured or hidden image of the interaction channel code.

The ACS computer 150 may also comprise a database 240. The database 240 may store data associated with the authentication process described in FIG. 1 or the registration process described with FIG. 4, including account information used to determine if the verifying enrollment request can be authenticated, a pseudonym, interaction channel codes, information used to derive interaction channel codes, passwords, device IDs, and the like.

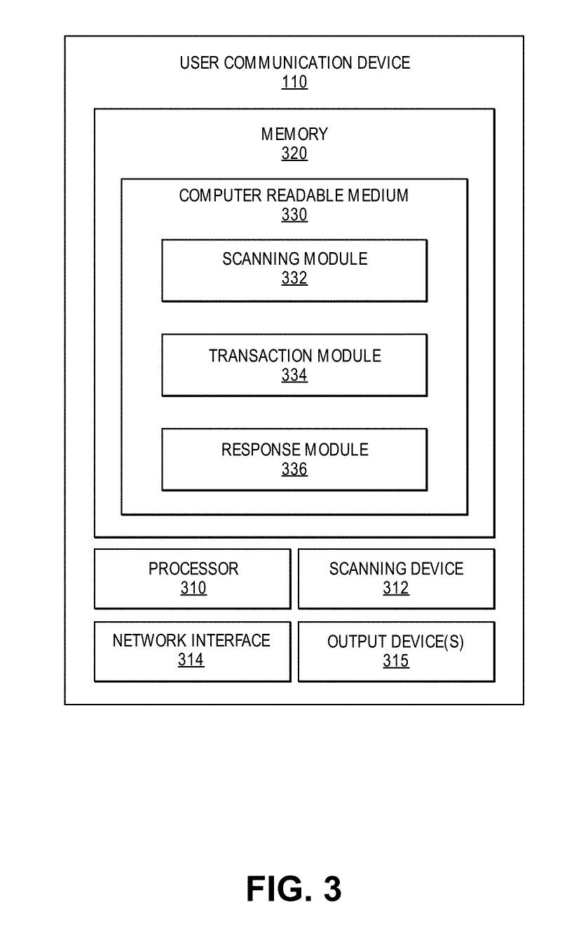

FIG. 3 shows a block diagram of a user communication device 110 according to one embodiment of the invention. The components comprise a processor 310, which may be coupled to a memory 320, scanning device 312, a network interface 314, and output device(s) 315 (e.g., a touchscreen, display, speaker, etc.). The memory 320 may comprise a computer readable medium 330 with a scanning module 332, transaction module 334, and a response module 336.

The scanning device 312, which may be a camera, may allow the user communication device 110 to capture one or more images of the portable device 120. For example, the user may operate the scanning device 312 to capture an image of the portable device 120 to generate the portable device image data. The scanning module 332 may include code, which when executed by the processor 310, may convert data from the scanning device to portable device image data.

The network interface 314 may allow the user communication device 110 to communicate with external computers. In some embodiments, the network interface 314 comprises an antenna, which may allow the user communication device 110 to communicate through a long range communication channel and with a mobile network operator.

The transaction module 334 may include code, which when executed by the processor 310, may conduct a transaction. For example, using the user communication device 110, the user may access the resource provider computer 130 via the Internet using a web browser (e.g., by browsing to www.acme.com for resource provider Acme Co.). In some examples, the user communication device 110 comprises an application module. In either implementation, the user communication device 110 may order resources from the resource provider computer 130 by identifying one or more resources provided by the resource provider computer 130 and providing the resource provider computer 130 with an account identifier associated with the portable device 120. The user may also provide an account identifier or other information, such as an expiration date, to the resource provider computer 130.

The response module 336 may include code, which when executed by the processor 310, may present and respond to prompts that are displayed on the output element(s) 315 of the user communication device 110.

In some examples, the response module 336 may include code, which when executed by the processor 310, can obtain, format, and transmit payment data for a transaction. In some embodiments, the response module 336, in conjunction with the processor 310, may retrieve payment data such as account identifiers, expiration dates, service codes, and other data stored in the memory 320 or a secure element of the user communication device 110.

FIG. 4 illustrates a flow chart for registering the portable device according to one embodiment of the disclosure. The registration process 400 may be conducted between a server computer 410 and a user communication device 415 and/or the user that operates the user communication device 415.

At step 420, the portable device may be manufactured by an entity operating the server computer 410 prior to the authorization process described with FIG. 1. The entity may be a bank, a payment processing organization, a data provider, etc. In some examples, the entity of the server computer 410 may conduct a manufacturing process to generate the portable device. The portable device may comprise a substrate, which may comprise one or more account credentials (e.g., account identifiers, account information, first verification values such as CVV, CVV2, dCVV, etc.), a magnetic stripe, a chip, identification of an entity associated with the authorization computer, or other information.

At step 425, the images or data from the portable device may be stored with the server computer 410. For example, the server computer 410 may capture one or more images from various angles of the portable device and store the images. The images may capture the account credentials, including at least one of a verification value or interaction channel code, to store as portable device image data. Alternatively or additionally, the data on the portable device may be stored on the server computer 410, but not necessarily in the form of image data.

At step 430, the portable device may be sent by the entity operating the server computer 410 to the user operating the user communication device 415. The portable device may be mailed to the user via shipping channels known in the art. In some examples, the portable device may be sent to the user electronically and received at the user communication device 415 via a telecommunications channel.

At step 440, the user may receive the portable device from the server computer 410. For example, the user may activate the portable device by calling a number or accessing a URL to confirm receipt of the portable device with the server computer 410. The activation may correlate the phone number of the user communication device 415 with the account credentials of the portable device.

At step 445, the user communication device 415 may capture one or more images of the portable device, including the front and the back of the portable device, and may enter additional registration or payment information as needed (e.g., billing address) via a browser or application stored with the user communication device 415. In some examples, the user communication device 415 captures the images using a camera integrated with the user communication device 415 after receiving a prompt from the server computer 410. Optionally, the user may enter the account identifier, name, expiry date, or a three or four digit security code.

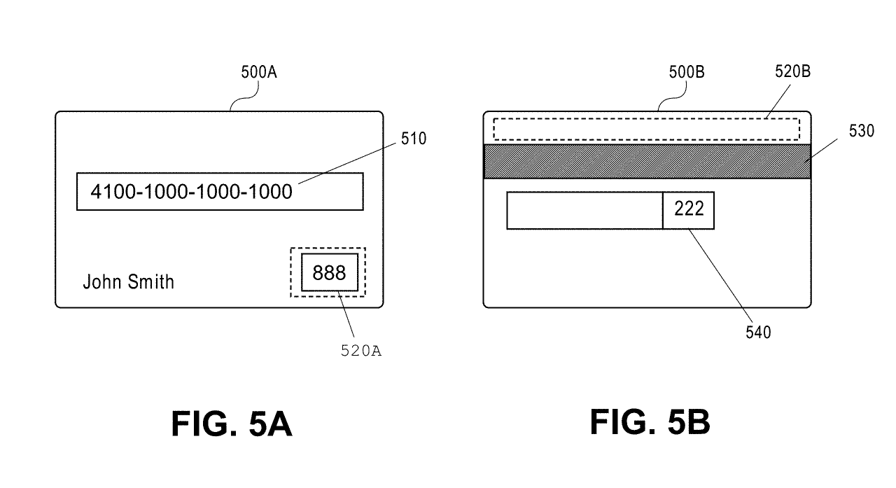

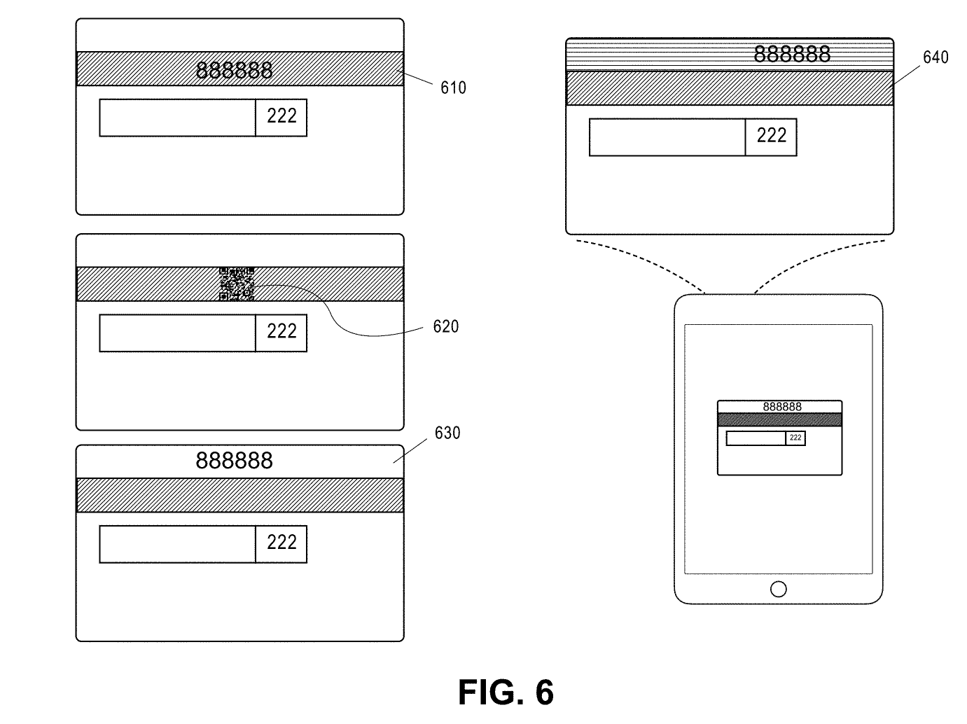

At least one of the images may include the interaction channel code. The image data may include a portion of the portable device that displays the interaction channel code, as illustrated in FIGS. 5-6.

FIGS. 5A-5B show illustrative portable devices according to one embodiment of the disclosure. The portable device 500 may comprise a front 500A and back 500B of the portable device 500 and one or more account credentials 540 (e.g., account identifiers, account information, first verification values such as CVV, CVV2, dCVV, etc.), a magnetic stripe 530, entity associated with the authorization computer, or other information. In this illustration, the front of the portable device 500A may display an account identifier 510. The front of portable device 500A also typically includes other data, such as the name of the account holder and the expiration date of the portable device.

The back of the portable device 500B may include a magnetic stripe 530 which is typically affixed to the substrate. The magnetic stripe 530 may function as a data storage region that is “read” or accessed by a card reader or other form of access device. Magnetic stripe 530 may include one or more distinct data storage sub-regions, such as “tracks.”

An interaction channel code 520A, 520B may be displayed on either the front or the back of the portable device 500. The interaction channel code is displayed on both the front of the portable device at 520A and the back of the portable device at 520B. It may be displayed at any other suitable location of the portable device.

In some examples, the user communication device 110 may capture an image of the front 500A or the back 500B of the portable device, or a portion of the portable device in order to generate portable device image data.

FIG. 6 shows illustrations of portable device image data that may be captured by the user communication device 110. The interaction channel code may comprise a number, identifier, image, or other value that helps verify that a user is in possession of the portable device. In any of these examples, the interaction channel code may be different than verification values that are also printed or embossed with the portable device.

In example 610, the interaction channel code is hidden in the magnetic stripe that is adhered to the portable device. An image processing algorithm may determine the interaction channel code by subtracting the images of the tracks in the magnetic stripe (e.g., the color, the pattern, etc.) to identify the interaction channel code within. The interaction channel code may be a different color, embossed texture, or format other than tracks, so that the image processing can identify the differences.

In example 620, the interaction channel code is encoded in a machine readable code and hidden in the magnetic stripe that is adhered to the portable device. For example, rather than the interaction channel code being printed with the track data as illustrated with example 610, the interaction channel code may be encoded in a two-dimensional code and printed with the track data. When the image process algorithm subtracts the image of the track data from the two-dimensional code, a second process may decode the two-dimensional code to determine the interaction channel code encoded within.

In example 630, the interaction channel code is a unique number printed above the magnetic stripe that is adhered to the portable device. For example, the verification value “222” may be printed below the magnetic stripe and an interaction channel code “88888” may be printed above the magnetic stripe.

In example 640, the interaction channel code is hidden with a mask or otherwise optically obscured. The interaction channel code can be read by using an application module stored in the user communication device 415 or server computer 410. For example, the interaction channel code may be printed on the portable device in a blue color. A red colored dots may be printed on top of the interaction channel code. When a red filter application is applied to the interaction channel code, the red layer may be subtracted, leaving only the blue color with the verification value to be displayed. Any other method of hiding the interaction channel code may be used in other embodiments.

These examples in FIGS. 5-6 are provided for illustration purposes and not meant to be limiting to the disclosure. For example, the image processing may be conducted at either the user communication device 415 or server computer 410.

Returning to FIG. 4, at step 450, the user communication device 415 may transmit one or more images of the portable device in the form of portable device image data to the server computer 410. The images and/or additional information may be encrypted using public/private key pairs. The message may also be sent using channel encryption.

At step 460, the server computer 410 receives image data for the one or more images of the portable device from the user communication device 415.

At step 465, the server computer 410 can authenticate the interaction channel code from the portable device image data. For example, it may generate an interaction channel code independently and then compare the generated code to the received interaction channel code. If the codes match, the server computer 410 may look up and determine if that code is being used with the proper transaction channel. The answer is affirmative, then the portable device may be authenticated and the transaction may also be authenticated.

In some examples, the server computer 410 or third party on behalf of server computer 410, uses the message header or metadata that accompanies the message that transmits the portable device image data to verify the portable device and user operating the user communication device (e.g., account holder). The server computer may verify account information (e.g., account number, account holder name, expiry date, CVV2), the image of the portable device including color, design of the substrate, portable device name (e.g., Mileage Plus), issuer logo, telephone numbers, hologram, and/or verifies portable device specific information (bar code, QR code, frequent flier program number).

The server computer 410 may verify the information and either allow the registration or payment to proceed, request additional information, or deny the registration process. In some examples, the received portable device image data may be deleted or encrypted to increase security.

In some examples, the user communication device 415 may not store the portable device image data after the data is transmitted to the server computer 410. The portable device image data may be deleted or encrypted to increase security.

In some examples, the user communication device 415 may add the portable device to a digital wallet. For example, the user communication device 415 may provide a registration process to add a portable device to the digital wallet. The user may type or otherwise provide the account credentials (e.g., account number, account holder name, expiry date, CVV2, etc.). The registration process may also accept an image of the portable device to initiate the registration process. The account credentials can be automatically recognized from the image and transmitted to server computer 410 and/or issuer computer associated with the portable device. The account credentials may be stored with the digital wallet associated with the user and/or user communication device 415, and transmitted to the server computer 410 according to the process described in FIG. 4. Once the account information is verified by the server computer 410 and/or issuer computer associated with the portable device, an image of the verified portable device may be displayed with the digital wallet.

In some examples, the user communication device 415 may add the portable device to an account with a merchant. For example, the merchant may provide a web page or software application stored with the user communication device 415 for accepting account credentials. The user may type or otherwise provide the account credentials (e.g., account number, account holder name, expiry date, CVV2, etc.) to the web page and/or provide an image of the portable device to initiate the registration process with the merchant. The account credentials may be transmitted to server computer 410 and/or issuer computer associated with the portable device for verification. The account credentials may be stored with the merchant, and transmitted to the server computer 410 according to the process described in FIG. 4.

Embodiments of the invention have a number of advantages. First, embodiments of the invention can utilize an interaction channel code on a portable device to improve security. The interaction channel code can be used in only one type of interaction channel. This limits any exposure if a fraudulent user tries to use the interaction channel code in another interaction channel. Also, by taking a picture of the portable device with the interaction channel code as an authentication mechanism, a remote server computer can be assured that the person conducting the transaction is in possession of an authentic portable device. This serves as another authentication factor in addition to an authentication factor such as a password. Thus, embodiments of the invention provide for improve data security over conventional systems.

The software components or functions described in this application, may be implemented as software code to be executed by one or more processors using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may also reside on or within a single computational apparatus, and may be present on or within different computational apparatuses within a system or network.

Some embodiments of the present invention can be implemented in the form of control logic in software or hardware or a combination of both. The control logic may be stored in an information storage medium as a plurality of instructions adapted to direct an information processing device to perform a set of steps disclosed in an embodiment of the present invention. Based on the disclosure and teachings provided herein, a person of ordinary skill in the art will appreciate other ways and/or methods to implement the present invention.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

All patents, patent applications, publications, and descriptions mentioned above are herein incorporated by reference in their entirety for all purposes. None is admitted to be prior art.

What is claimed is:

1. A method comprising:
receiving, by a user communication device, an authentication request message;
capturing, by the user communication device, an image of a portable device comprising an interaction channel code;
generating, by the user communication device, portable device image data in response to capturing the image of the portable device; and
transmitting, by the user communication device, the portable device image data to a server computer, wherein the server computer thereafter determines the interaction channel code from the portable device image data and generates validation data after determining that the interaction channel code is authentic.

2. The method of claim 1, where the server computer is an access control server.

3. The method of claim 1, wherein the authentication request message is associated with accessing data.

4. The method of claim 1, wherein the method further comprises:
receiving, the validation data from the server computer; and
transmitting the validation data to a resource provider computer, and wherein the resource provider computer generates and transmits an authorization request message for a transaction to an authorization computer for authorization.

5. The method of claim 1, wherein the interaction channel code identifies whether a transaction is limited to an electronic transaction.

6. The method of claim 1, wherein the interaction channel code is only used in one interaction channel.

7. The method of claim 1, wherein the interaction channel code is on the portable device, but can only be viewed using image filtering software on the user communication device.

8. The method of claim 1, wherein the portable device is a card.

9. The method of claim 1, wherein the interaction channel code is derived from other information associated with the portable device.

10. A user communication device:
a processor; and
a computer readable medium coupled to the processor, the computer readable medium comprising code, executable by the processor to implement a method comprising
receiving an authentication request message,
capturing an image of a portable device comprising an interaction channel code;
generating portable device image data in response to capturing the image of the portable device; and
transmitting the portable device image data to a server computer, wherein the server computer thereafter determines the interaction channel code from the portable device image data, and generates validation data indicating that the portable device has been authenticated after determining that the interaction channel code is authentic.

11. The user communication device of claim 10, where the user communication device is a mobile phone.

12. The user communication device of claim 110, wherein the validation data comprises a cryptogram.

13. The user communication device of claim 10, further comprising:
filtering software on the user communication device for filtering an obscured image of the interaction channel code on the portable device.

14. The user communication device of claim 10, wherein the interaction channel code is only valid for one interaction channel.

15. The user communication device of claim 10, wherein the portable device is a card.

16. A method comprising:
transmitting, by a server computer, an authentication request message to a user communication device;
receiving, by the server computer from the user communication device, portable device image data of a portable device comprising an interaction channel code;
determining, by the server computer, the interaction channel code from the portable device image data; and
generating, validation data after determining that the interaction channel code is authentic.

17. The method of claim 16, wherein the server computer is an access control server.

18. The method of claim 16, wherein the portable device is a card.

19. The method of claim 16, further comprising:
determining that the interaction channel code is associated with a single interaction channel, and further determining that a transaction being conducted with the portable device uses the single interaction channel.

20. The method of claim 19, wherein the transaction being conducted is to access data from the server computer.
